(19) United States
(12) Patent Application Publication
(10) Pub. No.: US 2009/0051181 A1
(43) Pub. Date: Feb. 26, 2009

(54) HEAVY-DUTY ROUNDSLING

(76) Inventors: Francois J.V. Goossens, Hamme (BE); Edwin J. Grootendorst, Holtum (NL)

Correspondence Address: NIXON & VANDERHYE, PC, 901 NORTH GLEBE ROAD, 11TH FLOOR, ARLINGTON, VA, 22203, US

(21) Appl. No.: 12/097,984

(22) PCT Filed: Nov. 28, 2006
(86) PCT No.: PCT/EP2006/011406

§ 371 Date: Sep. 12, 2008

(30) Foreign Application Priority Data
Dec. 22, 2005 (EP) 05078013.9

(51) Int. Cl. B66C 1/18; D07B 1/00

(52) U.S. Cl. 294/74; 442/181

(57) ABSTRACT

The invention relates to a heavy-duty roundsling, which comprises an endless load-bearing core containing multiple turns of a strand material comprising high-performance fibres, and a protective cover made from interlaced strands comprising high-performance fibres, and wherein the mass ratio of high-performance fibres in the core to high-performance fibres in the cover is from 0.15 to 2.0. Said roundsling shows an advantageous combination of properties, like high strength, low weight, and high durability; enabling a higher number of lifting operations than known metal or synthetic slings, especially of heavy goods with e.g. sharp edges.

The invention relates to a heavy-duty roundsling, which is used as connecting means between a lifting or other handling device, and heavy goods that are to be handled, such as loading or unloading. More specifically the invention relates to a flexible heavy-duty roundsling that comprises an endless load-bearing core containing multiple turns of a strand material comprising high-performance fibres, and a protective cover.

Such a roundsling is for example known from U.S. Pat. No. 4,850,629 and U.S. Pat. No. 5,651,572. These patent publications disclose roundslings comprising a load-bearing core in the form of a plurality of parallel turns (also called loops) of load-bearing fibrous strand material contained within tubular cover means. Such roundslings are commercially available under the trademark Slingmax® and are further described at a.o. www.slingmax.com/tpcx.htm. These products, which are of sizes of up to about 500.000 lbs vertical rated lifting capacity (with 5/1 design or safety factor), are indicated to have a core based on high-performance fibres, and a two-layered outer cover made from polyamide fibres, referred to as Covermax®, for improved abrasion resistance. These roundslings, which further comprise a fibre optic internal inspection system, are featured as flexible, light weight, ergonomic slings that can replace wire rope slings for lifting heavy goods.

For repetitive handling of heavy goods, for example loading and unloading in harbours of cargo transported in bulk (in which case the term stevedoring is frequently used), wire rope slings, steel hoisting mats or chain slings are still commonly used. The use of steel-based slings, however, presents some serious disadvantages. First of all, their high mass hampers ergonomic handling, and often requires two workmen (in view of regulations). Nevertheless, shoulder- and back-complaints are very common for harbour workers and the like. In addition, broken steel wires may protrude from the sling, and such ‘meat hooks’ pose a high risk for hand and other injuries. The use of steel-based slings may furthermore damage the goods to be handled.

The known heavy-duty roundsling based on synthetic fibres can replace wire rope slings in some cases, but problems are still encountered upon handling of, for example, heavy goods that are highly abrasive or have sharp edges, such as unpacked steel coils. In such cases, the synthetic roundslings show a short service liftetime: after only a limited number of lift jobs damage, like tears or rips, or even cuts in (at least) the cover of the roundsling are observed. Safety regulations generally require removing from service (for reparation or even discarding) of a roundsling of which the protective cover is damaged; for example when fibres of contrasting colour present in an inner layer of the cover or in the core become visible as warning signal. This makes application of such synthetic slings unacceptable, for safety and economic reasons.

The strength of a roundsling is mainly determined by the strength of the core, the cover mainly serving to protect the core. For this reason the core is by far the largest part of the roundsling, the mass ratio between core and cover normally is about 4-6. In order to increase the service lifetime of a roundsling additional protective pads between the roundsling and the goods are sometimes used. Such pads, however, need to be manually placed at critical spots, which action reduces the average number of lifts per time unit significantly (e.g. with a factor 2). In addition, such pads may not be put at the right spot, or may shift during use; resulting in less adequate, or even unsafe functioning. Therefore the use of roundslings containing synthetic fibers is hampered.

There is thus a need in industry for a lifting sling that allows easy and safe goods handling by workers, and which can perform many lifting jobs, also in repetitive handling sharp-edged goods. The present invention aims to provide such an improved roundsling.

This aim is achieved according to the invention with a heavy-duty roundsling, which comprises an endless load-bearing core containing multiple turns of a strand material comprising high-performance fibres, and a protective cover made from interlaced strands comprising high-performance fibres, and wherein the mass ratio of the high-performance fibres in the core to the high-performance fibres in the cover is from 0.15 to 2.0.

Although strength of the roundsling and the capability of bearing loads is mainly due to the core as explained above, yet surprisingly with a roundsling having such highly unusual thick cover and thin core, a roundsling is obtained with an acceptable strength but also a very much increased service life. The roundsling according to the present invention so surprisingly shows an advantageous combination of properties, like high strength, low weight, and high durability. The roundsling has high resistance to abrasion, tearing, and/or cutting, and can safely perform a higher number of lifting operations than known metal or synthetic slings, especially of heavy goods with e.g. sharp edges. Repetitive handling of goods with the roundsling according to the invention further poses a low risk of damaging the goods. The roundsling has a low mass, and can be easily used by one worker. Being made from synthetic fibres, there is low risk of causing cuts or other injuries to workmen.

U.S. Pat. No. 5,492,383 also discloses a roundsling with improved cut-resistance, but proposes to locally apply a certain length of an additional 3-layered sleeve, comprising an inner woven layer made from high-performance fibres sandwiched between two wear-resistant panels, around a core of high-performance endless parallel fibres already enclosed in a tubular covering.

Within the context of the present application, a heavy-duty roundsling is understood to be a sling suitable for handling bulk goods; having preferably a vertical working load limit (WLL linear) in the range 10 to 50 metric tons (mt; WLL according to NEN EN1492-2; note that in Europe a safety or design factor of 7/1 is used vs 5/1 in the US and 6/1 in Asia). Lifting of lower mass objects poses fewer problems and also can be done with less performing slings, whereas bulk lifting goods generally have a mass of at most about 50 mt. More preferably therefore, the heavy-duty roundsling of the invention has a WLL linear of 12-40, or 15-30 mt. In a specifically preferred embodiment, the roundsling has a WLL linear of about 20 mt.

The heavy-duty roundsling according to the invention comprises at least one endless load-bearing core containing multiple turns of a strand material comprising high-performance fibres (also called high-performance fibres in the core). In order to optimize strength properties of the roundsling, the turns of strands in the core are oriented in parallel as much as possible.

The strand material can be of various structures, but preferably has a structure wherein the fibres are oriented predominantly in the longitudinal direction for efficient use of their strength properties. Suitable strand constructions include parallel yarns, twisted yarns, and cords and ropes of various structures, including laid and braided constructions, etc. Preferably, a cord or rope is used as strand material, this has the advantage that the roundsling can be made more efficiently; less turns are needed to reach a desired strength, and especially in case of a pre-formed tubular cover a rope or cord can be more easily inserted in the cover.

In a preferred embodiment of the invention, the strand material is a laid rope. Preferably, the two ends of the laid rope are connected with a splice to result in high strength efficiency. A roundsling having such a splice, and a method of making it, is described in the WO 2004/067434 A1 publication, which is hereby incorporated by reference.

High-performance fibres are understood to be synthetic (polymeric) fibres having a tenacity of greater than 1.5 N/tex and an elongation at break (eab) of below 10%, as measured with a test procedure based on ASTM D885M. The high-performance fibres in the core strand preferably have a tenacity of greater than 2.0, or even 2.5 N/tex Suitable examples of high-performance fibres include fibres made from aromatic polyamide (e.g. aramids commercially available as Twaron®, Kevlar®, Technora®), aromatic polyester (like Vectran®), polybisoxazole (e.g. Zylon®), or from ultra-high molar mass polyethylene (UHMWPE, also called high-performance polyethylene (HPPE) fibres; e.g. available as Dyneema® or Spectra®).

The core strand may contain only one type of high-performance fibres, but also a mixture of two or more types. Preferably, the strand contains HPPE fibres. These fibres made from UHMWPE show very high strength relative to their mass, allowing further weight reduction of the sling. Other advantageous properties include high abrasion resistance, good fatigue resistance under dynamic loading, and excellent chemical and UV resistance.

HPPE fibres, filaments and multi-filament yarn, can be prepared by spinning of a solution of UHMWPE in a suitable solvent into gel fibres and drawing the fibres before, during and/or after partial or complete removal of the solvent; that is via a so-called gel-spinning process. Gel spinning of a solution of UHMWPE is well known to the skilled person; and is described in numerous publications, including EP 0205960 A, EP 0213208 A1, U.S. Pat. No. 4,413,110, GB 2042414 A, EP 0200547 B1, EP 0472114 B1, WO 01/73173 A1, and in Advanced Fiber Spinning Technology, Ed. T. Nakajima, Woodhead Publ. Ltd (1994), ISBN 1-855-73182-7, and in references cited therein.

UHMWPE is understood to be polyethylene having an intrinsic viscosity (IV, as measured on solution in decalin at 135° C.) of at least 5 dl/g, preferably of between about 8 and 40 dl/g. Intrinsic viscosity is a measure for molar mass (also called molecular weight) that can more easily be determined than actual molar mass parameters like Mₙ and M_{w}. There are several empirical relations between IV and M_{w}, but such relation is dependent on molar mass distribution. Based on the equation M_{w}=5.37*10⁴ [IV]^{1.37} (see EP 0504954 Al) an IV of 8 dl/g would be equivalent to M_{w} of about 930 kg/mol. Preferably, the UHMWPE is a linear polyethylene with less than one branch per 100 carbon atoms, and preferably less than one branch per 300 carbon atoms; a branch or side chain or chain branch usually containing at least 10 carbon atoms. The linear polyethylene may further contain up to 5 mol % of one or more comonomers, such as alkenes like propylene, butene, pentene, 4-methylpentene or octene.

In a preferred embodiment, the UHMWPE contains a small amount, preferably at least 0.2, or at least 0.3 per 1000 carbon atoms, of relatively small groups as pending side groups, preferably a C1-C4 alkyl group. Such a fibre shows an advantageous combination of high strength and creep resistance. Too large a side group, or too high an amount of side groups, however, negatively affects the process of making fibres. For this reason, the UHMWPE preferably contains methyl or ethyl side groups, more preferably methyl side groups. The amount of side groups is preferably at most 20, more preferably at most 10, 5 or at most 3 per 1000 carbon atoms.

The HPPE fibres in the roundsling according to the invention may further contain small amounts, generally less than 5 mass %, preferably less than 3 mass % of customary additives, such as anti-oxidants, thermal stabilizers, colorants, flow promoters, etc. The UHMWPE can be a single polymer grade, but also a mixture of two or more different polyethylene grades, e.g. differing in IV or molar mass distribution, and/or type and number of comonomers or side groups.

Preferably, the strand contains at least 50 mass % of high-performance fibres (based on total strand mass). The strand may further contain other fibres of lower strength, both as continuous filaments or staple fibres, and/or other components, like additives to improve performance.

In order to reduce the weight of a roundsling of a certain WLL, the strand preferably contains at least 60, 70, 80, or even 90 mass % of high-performance fibres. Most preferably, the strand material in the core substantially consists of high-performance fibres.

The load-bearing core of the roundsling according to the invention may in addition to strand material further contain other components known in the art, like a coating material. Preferably, the core contains less than about 25, or less than 20 or 15 mass % of other components.

The heavy-duty roundsling according to the invention comprises an endless load-bearing core and a protective cover made from interlaced strands, which cover fully encloses the load-bearing core. A cover made from interlaced strands is understood to indicate that, unlike in the core wherein the multiple turns of the strand run mainly parallel to each other, the strands run in at least two different directions and cross each other. Suitable cover constructions include woven, knitted, braided and the like fabrics or textiles. The cover can be a single fabric, but also multi-layered; including combinations of different fabric structures.

Mounted around the core of the roundsling, the cover is in a hollow tubular form. The tubular form can have been made from flat fabric by folding a piece of fabric of suitable size, e.g. around turns of core strands, and subsequently connecting the sides, e.g. with some overlap (and then connecting both ends of the tube so formed). Preferably, the roundsling has a cover that was made directly in a hollow tubular form by a suitable textile technique like (round or circular) weaving, knitting or braiding, and subsequently the core was made inside this cover by making turns of strands (followed by connecting the ends of the tubular cover together); or alternatively a round cover is made in situ around the core by e.g. a braiding technique. The advantage of such pre-formed or such in situ formed hollow tubular or round cover is that the cover, and thus the roundsling, has uniform properties over its surface (it being without connections or overlapping parts); reducing the risk of local damaging.

Preferably, the cover is a 3-dimensional (also referred to as 3D) fabric; that is the strands run and cross each other in 3 directions. 3D textiles are known in the art, and can be made with different textile techniques; including knitting, stitching, braiding and weaving.

More preferably, the protective cover is a 3D woven fabric, comprising warp, weft and binder strands or threads; more preferably a 3D hollow woven fabric (in hollow tubular form). Such 3D hollow fabric can be made with e.g. circular (or round) weaving techniques, or with a multi-layer flat weaving technique wherein the layers are connected at the edges to form the wall of a tubular construction.

In a further preferred embodiment of the invention, the cover is a multi-layered 3D woven textile construction comprising at least 2 woven layers interconnected by binder threads, more preferably between 3 and 9 interconnected layers, optionally made in hollow tubular form. The warp, weft and binder threads can be single-, but also multi-stranded.

The heavy-duty roundsling according to the invention comprises an endless load-bearing core and a protective cover made from interlaced strands comprising high-performance fibres (also called high-performance fibres in the cover).

Analogous to the fibres in the core, high-performance fibres in the cover are understood to be synthetic (polymeric) fibres having a tenacity of greater than 1.5 N/tex and an elongation at break (eab) of below 10%, as measured with a test procedure based on ASTM D885M. The high-performance fibres in the cover strands preferably have a tenacity of greater than 2.0, or even 2.5 N/tex. Suitable examples of high-performance fibres in the cover include fibres made from an aromatic polyamide (e.g. aramids commercially available as Twaron®, Kevlar®, Technora®), an aromatic polyester (like Vectran®), a polybisoxazole (e.g. Zylon®), or from an ultra-high molar mass polyethylene (e.g. available as Dyneema® or Spectra®; also called HPPE fires).

The interlaced strands may contain one type of high-performance fibres, but also strands containing different fibres, or based on a mixture of two or more types, can be chosen.

The high-performance fibres in the cover can be the same as, but can also be different from the high-performance fibres in the core.

Preferably, the interlaced strands contain HPPE fibres, because of the good abrasion- and cut-resistance of these fibres in such cover construction. Further preferred embodiments are analogous as indicated above for the core strand.

Preferably, the interlaced strands contain at least 50 mass % of high-performance fibres (based on total interlaced strand mass). The strands may further contain other fibres of lower strength, both as continuous filaments or staple fibres, and/or other components, like additives to improve performance. The other fibres may be organic (polymeric) fibres or inorganic (like glass or metal) fibres, and can be in the form of continuous filaments and/or staple fibres. The other fibres can also be so-called composite yarns, containing combinations of different fibres; like a strand of glass fibres (or steel wire) wrapped with synthetic fibres, to further improve properties like cut-resistance. In order to reduce the weight of the roundsling, the cover strands preferably contain at least 60, 70, 80, or even 90 mass % of high-performance fibres. Most preferably, the interlaced strands substantially consist of high-performance fibres.

The protective cover of the roundsling according to the invention may in addition to the strands further contain other components known in the art, like a coating material. Preferably, the cover contains less than about 25, or less than 20 or 15 mass % of other components.

In a preferred embodiment, the strands in both cover and core contain the same high-performance fibres; that is the high-performance fibres in the core and in the cover are the same. More preferably, the strand in core and the strands in the cover substantially consist of HPPE fibres, to result in a roundsling that combines high WLL with relatively low total mass, and high resistance to abrasion or cutting.

The heavy-duty roundsling according to the invention comprises an endless load-bearing core and a protective cover, wherein the mass ratio of high-performance fibres in the core to high-performance fibres in the cover is from 0.15 to 2.0. The cover is made from strands comprising high-performance fibres, which fibres constitute at least about 33% of the total mass of the high performance fibres in both core and cover, to obtain the desired protective function. A higher relative mass of high performance fibres in the cover generally results in improved performance and longer service life. The said mass ratio is therefore preferably smaller than 1.5, 1.0, 0.9, 0.8 or even smaller than 0.7. Because increasing the thickness of the cover will increase total mass of the roundsling of a certain lifting capacity, the mass ratio of high-performance fibres in core to cover is at least 0.15; preferably larger than 0.2, 0.15, 0.25, 0.3, or even larger than 0.4, to arrive at a favourable combination of properties.

The protective cover of the roundsling according to the invention, comprising high-performance fibres and optionally other fibres and components, preferably has a mass that is at least 50 mass % of the total mass of the roundsling, more preferably at least 60 mass %. Preferably, the mass of the cover forms at most 85 mass % of the total mass of the roundsling, more preferably at most 80 mass %.

The (optimum) relative mass of the cover is also dependent on the capacity, or WLL, of the roundsling; a certain well-functioning cover can be used on different cores of size within indicated limits. For a 20 mt roundsling, for example, made substantially from high-performance fibres, the high-performance fibres in the cover form preferably about 60-70 mass % of the total amount of high-performance fibres in the roundsling construction.

The roundsling according to the invention may further comprise other components, including information labels, and warning means to indicate e.g. overstretching or overloading of the roundsling.

The invention further concerns methods of making the roundsling according to the invention. One way of making the roundsling comprises the steps of making an endless load-bearing core by forming multiple turns of a strand material comprising high-performance fibres, and providing a protective cover made from interlaced strands comprising high-performance fibres around said core such that it fully encloses the core.

Another method of making a roundsling according to the invention comprises a step of making a hollow tubular fabric by interlacing strands comprising high-performance fibres around an endless load-bearing core containing multiple turns of a strand material comprising high-performance fibres, such that the fabric fully encloses the core.

A further method of making a roundsling according to the invention comprises the steps of making a hollow tubular fabric by interlacing strands comprising high-performance fibres, and subsequently forming an endless load-bearing core inside said cover from multiple turns of a strand material comprising high-performance fibres.

Preferred embodiments for core and cover in said methods are analogous to those discussed above for the roundsling according to the invention.

The invention further relates to the use of a 3D woven fabric comprising at least 50 mass % of high-performance fibres and having a specific mass of at least 1500 g/m² as protective means on elongate fibrous structures, e.g. to protect elongated fibrous structures against damage caused by abrasive or cutting forces.

Elongate fibrous structures are understood to be various types of ropes constructions and the like; which contain fibres and have a length dimension much larger than transverse dimensions.

Preferably, the use relates to a hollow 3D woven fabric (made in tubular form) having above characteristics.

The use according to the invention concerns a 3D woven fabric having a specific mass, also referred to as linear density, of at least about 1500 g/m². The specific mass relates to the fabric forming the wall of a cover, not the mass of e.g. the double layer of a flattened hollow structure. To further enhance its protective function, the specific mass preferably is at least about 2000, 2500, 3000 or even 3200 g/m². Too high a specific mass will make handling of the fabric, as well as manufacturing a roundsling therewith, more difficult; the 3D woven fabric used has therefore preferably a specific mass of at most about 8000, or at most 7500 g/m².

In a preferred embodiment of the invention, a multi-layered 3D woven fabric comprising at least 2 interconnected layers is used as protective means. More preferably, such fabric comprising between 3 and 9 interconnected layers, optionally in hollow tubular form, is used.

The use according to the invention concerns a 3D woven fabric comprising at least 50 mass % of high-performance fibres. High-performance fibres are understood to be synthetic (polymeric) fibres having a tenacity of greater than 1.5 N/tex and an elongation at break (eab) of below 10%, as measured with a test procedure based on ASTM D885M. The fibres in the protective fabric preferably have a tenacity of greater than 2.0, or even 2.5 N/tex. Suitable examples of high-performance fibres include fibres made from an aromatic polyamide (e.g. aramids commercially available as Twaron®, Kevlar®, Technora®), an aromatic polyester (like Vectran®), a polybisoxazole (e.g. Zylon®), or from an ultra-high molar mass polyethylene (e.g. available as Dyneema® or Spectra®).

The 3D woven fabric used according to the invention may contain one type of high-performance fibres; but also a mixture of two or more types can be chosen. Preferably, the fabric contains HPPE fibres, because of the good abrasion- and cut-resistance of these fibres. Further preferred embodiments for HPPE fibres are analogous to those described above for a roundsling according to the invention.

In addition to at least 50 mass % of high-performance fibres (based on total mass of the fabric), the 3D woven fabric used may further contain other fibres of lower strength, and/or other components, like additives to improve performance (e.g. a coating), information labels, etc. The other fibres may be organic (polymeric) fibres or inorganic (like glass or metal) fibres, and can be in the form of continuous filaments and/or staple fibres. The other fibres can also be so-called composite yarns, containing combinations of different fibres; like a strand of glass fibres (or steel wire) wrapped with synthetic fibres.

In order to reduce its weight, the protective fabric preferably contains at least 60, 70, 80, or even 90 mass % of high-performance fibres. Most preferably, the fabric substantially consists of high-performance fibres.

In a special embodiment, the invention relates to the use of a 3D hollow (tubular) woven fabric comprising at least 90 mass % of HPPE fibres and having a specific mass of at least 2500 g/m² as protective means on elongate fibrous structures. Preferably, such structure is a roundsling.

The invention will now be further illustrated with some non-limiting experiments.

### Evaluation of Cover Materials

Several cover materials were tested on laboratory scale on abrasion- and cut-resistance. Some samples are used as cover on commercially available sling products:
Sample A is a plain woven fabric based on polyamide 66 (PA 66) fibres (obtained from Slingmax, US);
Sample B is a standard sleeve as used in roundsling protection; a plain woven made from polyethyleneterephthalate (PET) fibres (obtained from Unitex Holding BV, NL);
Sample C is a woven made from HPPE fibres provided with a plastic coating, and marketed by Samson Rope Technologies (US) as Pro-Gard eye & rope protector (also called chafe gear);
Samples D and E are hollow tubular 3D wovens, consisting of 4 woven plies constructed into a hollow tubular format having 2 layers forming the wall, which layers were made by spirally interweaving a single multi-stranded and twisted weft yarn within a multiplicity of warp yarns. The 2 woven layers forming the wall are held together using a multi-stranded and twisted binder yarn technique to create structural integrity. For sample D PET yarns, for sample E Dyneema® SK75 1760 dtex yarns were used in the warp, weft, and binder threads.

Following methods were applied:
Tensile properties of yarn: tensile strength (or tenacity) and elongation at break (or eab) are defined and determined on multifilament yarns with a procedure in accordance with ASTM D885M, using a nominal gauge length of the fibre of 500 mm, a crosshead speed of 50%/min and Instron 2714 clamps, of type Fibre Grip D5618C. On the basis of the measured stress-strain curve the modulus is determined as the gradient between 0.3 and 1% strain. For calculation of the tenacity, the tensile forces measured are divided by the titre, as determined by weighing 10 meters of yarn;
Abrasion resistance was tested on the cover materials by mounting a sample of cover on a support belt of about 6 cm width, placing the combination at 90° angle around a wheel of diameter 145 mm, the outer surface of which is formed by 18 spokes of 12 mm diameter, while keeping the rope under constant tension with a load of about 1300 kg. The wheel was rotated at 4 rpm; and the number of rotations was determined until the first contact of the supporting belt with the spokes of the wheel (visual determination);
Sawing resistance was determined by moving a steel wire rope of 10 mm diameter back and forward with amplitude of 140 mm at 1200 angle and with a load on the steel wire of 40 kg over a cover mounted on a 20 mm support rope, which support rope was held under constant load of 575 kg. The number of motions was determined until the the first contact between steel wire and support rope (visual determination);
Cutting resistance was measured by mounting a length of the cover material around a support rope, bending the cover over the edge of a stainless steel knife, and tensioning both ends of the rope at 150 mm/min in a tensile tester until the cover is cut. The result is reported as the force applied at cutting. The knife has a thickness of 10 mm, and an edged part of 6 mm, which is sharpened before every test with a Sandvik #3 file.

From the results listed in Table 1, it can be concluded that sample E shows the best overall performance; although the cutting test results show less differences between samples than the abrasion and sawing tests.

TABLE 1

| | | | | Abrasion | Sawing | |
|---|---|---|---|---|---|---|
| | | Specific | | resistance | resistance | Cutting |
| | Type of fibres; | mass | Thickness | (number of | (number of | resistance |
| Sample | construction | (g/m²) | (mm) | rotations) | motions) | (N) |
| A | PA66; | 1497 | 3.7 | 32 | 2200 | 15001 |
| | Plain woven | | | | | |
| B | PET; | 742 | 1.2 | 3 | 361 | 3663 |
| | plain woven | | | | | |
| C | HPPE; | 1046 | 1.5 | 21 | 12308 | 8589 |
| | coated woven | | | | | |
| D | PET; | 3616 | 4.8 | 49 | 5381 | 9235 |
| | multi-layered | | | | | |
| | 3D woven | | | | | |
| E | HPPE; | 3398 | 4.8 | 325 | 80898 | 11711 |
| | multi-layered | | | | | |
| | 3D woven | | | | | |

### EXAMPLE 1

A roundsling was made following the procedure as described in WO 2004/067034 A1, by making eight parallel turns of a rope inside a tubular cover, making a splice connection between the two ends of the rope, and connecting the two ends of the cover by sewing them together.

The rope used was a laid rope of construction 3×24×3/1760 dtex Dyneema® SK75. The applied cover was the same as sample F in Table 1 and described above. Dyneema® SK75 1760 dtex is a commercially available HPPE yarn (DSM Dyneema B.V., NL), having a tenacity of 35 cN/dtex and elongation at break of 3.4%.

The roundsling has a total mass of 12.2 kg, the cover mass is 8.2 kg; i.e. the ratio of HPPE fibres in the core to HPPE fibres in the cover ratio is about 0.49.

The roundsling has a vertical working load limit of 20 mt, and a minimum coefficient of utilization of 7, as described in and required by European standard NEN EN 1492-2.

This all-HPPE roundsling was evaluated versus standard steel hoisting mats of mass in the range 70-100 kg, in stevedoring steel coils of mass 15-25 ton per coil. In practice about half of coils are packaged, the remainder is transported in non-packaged form, meaning that slings used are in direct contact with the sharp edges of coils during lifting operations.

The steel hoisting mats have such a mass that handling needs to be performed by two workers. Steel hoisting mats were found to have a typical service lifetime of 150 to 200 lift jobs (on packaged and unpackaged coils).

The roundsling made from HPPE fibres could be handled by one worker during stevedoring, and showed hardly any visible damage after 521 lifting jobs (of which about 50% on unprotected steel coils); which is a much longer service life than standard steel-based products. Then the roundsling was further inspected by removing the cover, to reveal no visible damage to the core rope or fibres.

The average residual strength of the core rope was subsequently measured to be more than 70% of its initial strength, which is more than double of what is generally accepted as a minimum level of residual strength for a sling in use; indicating the tested roundsling could have safely performed many more lifting jobs.

Earlier comparative tests had already revealed that roundslings with a core based on HPPE fibres, and with various covers made from polyamide 66 or PET fibres (amongst others such covers as mentioned above) had to be taken out of service because of unacceptable damage (cut fibres) already after a few lifting jobs.

1. Heavy-duty roundsling, which comprises an endless load-bearing core containing multiple turns of a strand material comprising high-performance fibres, and a protective cover made from interlaced strands comprising high-performance fibres, and wherein the mass ratio of the high-performance fibres in the core to the high-performance fibres in the cover is from 0.15 to 2.0.

2. Roundsling according to claim 1 , wherein the core strand material is a rope.

3. Roundsling according to claim 1, wherein the high-performance fibres in the core are HPPE fibres.

4. Roundsling according to claim 1, wherein the core strand contains at least 90 mass % of high-performance fibres.

5. Roundsling according to claim 1, wherein the cover is a 3D fabric.

6. Roundsling according to claim 1, wherein the cover is a 3D woven fabric.

7. Roundsling according to claim 1, wherein the cover is a 3D hollow fabric.

8. Roundsling according to claim 1, wherein the high-performance fibres in the cover are HPPE fibres.

9. Roundsling according to claim 1, wherein the interlaced strands contain at least 90 mass % of high-performance fibres.

10. Roundsling according to claim 1, wherein the strands in core and cover substantially consist of HPPE fibres.

11. Roundsling according to claim 1, wherein the protective cover has a mass of from 50 to 85 mass % of the total mass of the roundsling.

12. Use of a 3D woven fabric comprising at least 50 mass % of high-performance fibres and having a specific mass of at least 1500 g/m² as protective means on elongate fibrous structures.
